(19) United States
(12) Patent Application Publication
(10) Pub. No.: US 2024/0352590 A1
(43) Pub. Date: Oct. 24, 2024

(54) METHOD AND SYSTEM FOR COLD DEPOSITION OF POWDERED MATERIALS ON A SUBSTRATE

(71) Applicant: CONCORDIA UNIVERSITY, Montreal (CA)

(72) Inventors: Christian MOREAU, Boucherville (CA); Ali DOLATABADI, Toronto (CA); Mehdi JADIDI, Toronto (CA); Fadhel BEN ETTOUIL, Montreal (CA); Marc LEBLANC, Saint-Jean-sur-Richelieu (CA); Sylvain DESAULNIERS, Candiac (CA); Ali AKBARNOZARI, Brossard (CA); Saeed GARMEH, Montreal (CA); Eric BESSETTE, Brossard (CA); Luc POULIOT, Saint-Bruno-de-Montarville (CA)

(21) Appl. No.: 18/688,010

(22) PCT Filed: Aug. 24, 2022
(86) PCT No.: PCT/CA2022/051280

§ 371 Date: Feb. 29, 2024

Related U.S. Application Data
(60) Provisional application No. 63/260,894, filed on Sep. 3, 2021.

(51) Int. Cl. C23C 24/04

(52) U.S. Cl. CPC C23C 24/04

(57) ABSTRACT

A method and a system for cold spray deposition of a solid material on a substrate, the system comprising a fluid jet unit; a heating unit; a nozzle, and a powder feeder; the fluid jet unit providing a fluid of a speed up to 1200 m/s and a pressure in a range between 150 and 620 MPa to the heating unit, the heating unit controlling a temperature of the fluid and outputting one of: a superheated and a supercritical fluid; the powder feeder injecting feedstock powder particles into a mixing chamber of the nozzle, the feedstock powder particles being accelerated to a speed above a critical velocity of the feedstock powder particles by the fluid within the nozzle, the nozzle being configured for acceleration of the fluid, mixing the fluid and the feedstock powder particles, and projecting the mixture onto the substrate.

### FIELD OF THE INVENTION

The present disclosure relates to a method and a system for depositing solid particles on substrates. More precisely, the present disclosure is concerned with a method and a system for depositing powdered materials using a liquid propellant.

### BACKGROUND OF THE DISCLOSURE

Thermal spray is widely adopted across a range of industries like aerospace, space, automotive, and power generation as a cost-effective and preferred method both to deposit protective coatings and for manufacturing new components or repairing and re-engineering worn or damaged components.

The cold spray has become a robust coating process that uses a high velocity propelling gas such as nitrogen or helium to accelerate particles without heating them to the melting point to deposit metallic layers on a substrate. In the method, usually a De Laval nozzle accelerate particles toward the substrate and the deformation of particles upon impact make the coating layers. Applications of cold spray range from repairing parts to additive manufacturing. Cold spray has been used to repair corroded magnesium helicopter components.

Thermal spray method and later the cold spray method have been developed in the last 120 years. First the coating method comprised spraying unmolten metals without using a converging-diverging nozzle. Then, a converging-diverging nozzle was used to accelerate particles for coating. The main development of cold spray over the years has been in three categories of apparatus, precursor, and application, including nozzle configurations, combination with laser components, control systems, and precursor, i.e., new feedstocks. However, few research tackle challenges and limitations related to propelling the particles and propellant material to spray particles.

Cold spray has become a robust coating method which uses a high velocity propelling gas such as nitrogen or helium to accelerate particles in order to deposit metallic layers on a substrate. Typically, in the regular cold spray method, solid powders are accelerated by a carrier fluid forced through a converging-diverging nozzle, to extremely high speeds above a critical velocity to form bonding to the substrate upon impact and to each other; depending on the material's properties, powder size and temperature. Cold spray has attracted high attention as a low-cost, environmentally friendly method for depositing particles without melting or oxidation, for formation of dense coatings and for additive manufacturing or 3D printing of functional metallic parts.

However, there are still limitations in this method. The deposition efficiency (DE), a dimensionless number defined as the ratio of additional mass after spraying to the original mass of the substrate (DE=Δm/Mₒ), is typically low for alloy powders, and the window of method parameters and powder sizes are limited; for instance, particles larger than about 40 μm are not accelerated at sufficient high velocity, or ceramic particles do not stick on substrates due to their high hardness. Issues still include high gas consumption, narrow range of sprayable materials, and technology limitations.

There is still a need in the art for a method and a system for cold deposition of powdered materials on a substrate.

### BRIEF DESCRIPTION OF THE DRAWINGS

In the appended drawings:

FIG. 1A is a schematical view of a system according to an embodiment of an aspect of the present disclosure;

FIG. 1B is a view of a system according to an embodiment of an aspect of the present disclosure; and

FIG. 2A is a schematical view of a nozzle according to an embodiment of an aspect of the present disclosure;

FIG. 2B shows a nozzle according to an embodiment of an aspect of the present disclosure;

FIG. 3 shows the pressure in the mixing chamber of the system as a function of the water temperature according to an embodiment of an aspect of the present disclosure;

FIG. 4 is a schematic view of a system for powder injection according to an embodiment of an aspect of the present disclosure; and

FIG. 5 shows a pattern of deposition on the substrate according to an embodiment of an aspect of the present disclosure.

### SUMMARY OF THE INVENTION

More specifically, in accordance with the present invention, there is provided a system for cold spray deposition of a solid material on a substrate, the system comprising a fluid jet unit; a heating unit; a nozzle and a powder feeder; the fluid jet unit providing a fluid of a speed up to 1200 m/s and a pressure in a range between 150 and 620 MPa to the heating unit, the heating unit controlling a temperature of the fluid and outputting one of: a superheated and a supercritical fluid; the powder feeder injecting feedstock powder particles into a mixing chamber of the nozzle, the feedstock powder particles being accelerated to a speed above a critical velocity of the feedstock powder particles by the fluid within the nozzle, the nozzle being configured for acceleration of the fluid, mixing the fluid and the feedstock powder particles, and projecting the mixture onto the substrate.

There is further provided a method for cold spray deposition of a solid material on a substrate by accelerating solid particles using a one of a superheated or supercritical fluid, the method comprising generating a fluid of a speed up to 1200 m/s and a pressure in a range between 150 and 620 MPa; controlling a temperature of the fluid to yield one of: a superheated and a supercritical fluid; injecting feedstock powder particles and the fluid into a mixing chamber of a nozzle, the feedstock powder particles being accelerated to a speed above a critical velocity of the feedstock powder particles by the fluid within the nozzle, the nozzle being configured for acceleration of the fluid, mixing the fluid and the feedstock powder particles; and projecting the mixture onto the substrate.

Other objects, advantages and features of the present invention will become more apparent upon reading of the following non-restrictive description of specific embodiments thereof, given by way of example only with reference to the accompanying drawings.

### DESCRIPTION OF EMBODIMENTS OF THE INVENTION

The present disclosure is illustrated in detail by the following non-limiting examples.

The present disclosure describes a cold spray method and a cold spray system using high pressure and high velocity superheated liquids or supercritical fluids to accelerate particles at increased particles velocity compared to when using gases, allowing deposition of particles of larger diameter and larger particle size distributions.

In the following, for purpose of illustration, cold spray using water as the liquid propellant is described to deposit copper particles on a steel substrate. The jet at the nozzle exit of the system is characterized as a function of the water temperature and of the water pressure. The coating microstructure and the deposition efficiency are characterized as a function of the spraying parameters, such as the fluid propellant pressure, the spraying distance, the substrate conditions, including substrate roughness and substrate temperature, and the powder size.

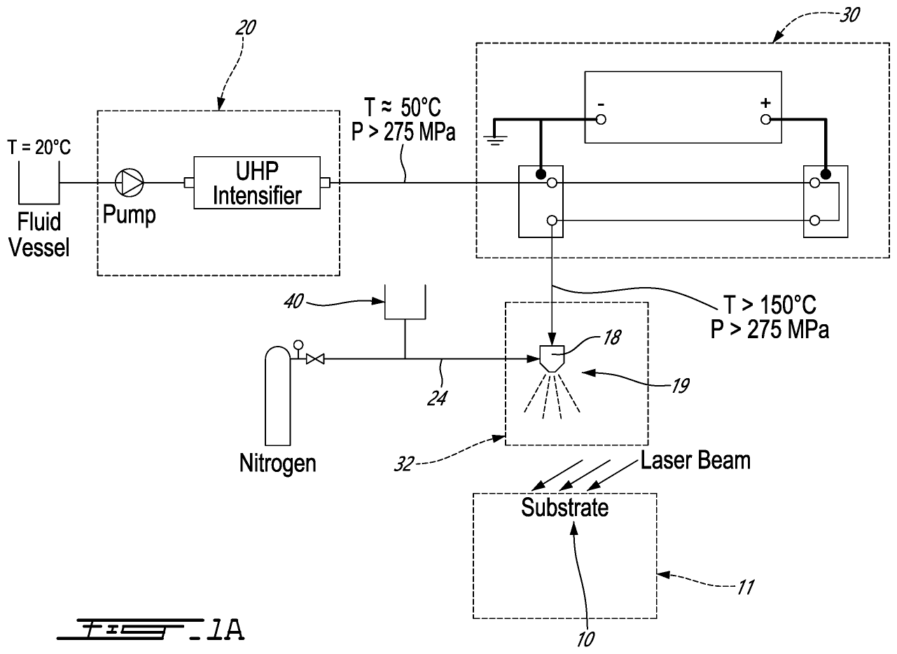

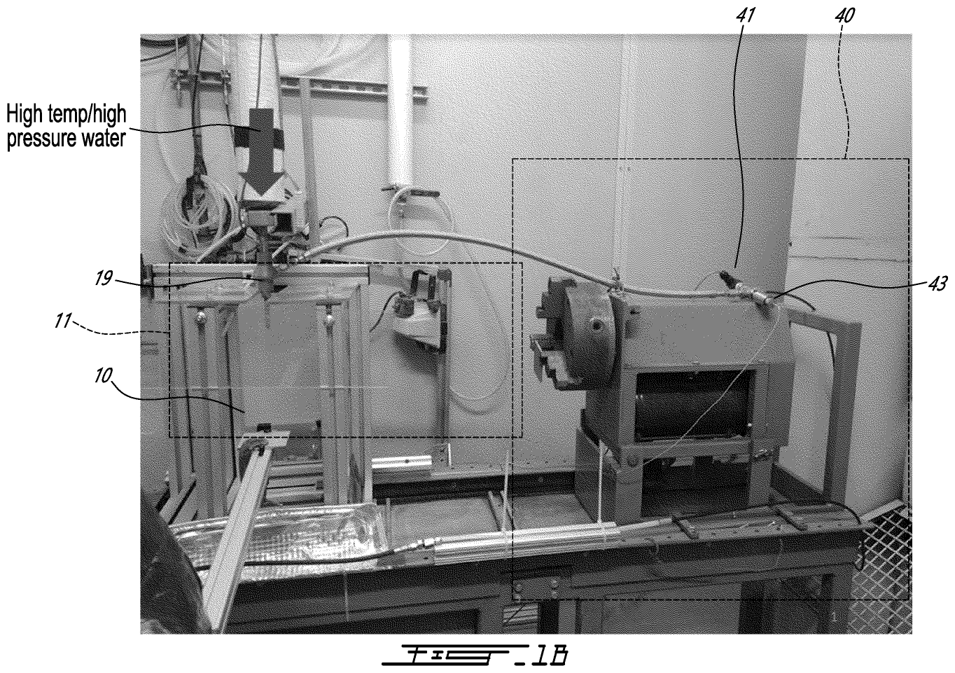

A system according to an embodiment of an aspect of the present disclosure as illustrated in FIGS. 1 for example, comprises a fluid jet unit 32, a heating unit 30, a nozzle 19, and a powder feeder 40.

The feedstock particles are accelerated to a speed above the critical velocity of the material by a flow of water within the nozzle 19 of the fluid jet unit 32, here a water jet unit since water is used as the liquid propellant. The heating unit 30 controls the temperature of the water 30, to increase the temperature of the water and consequently increase the evaporation rate of droplets in the spray before reaching the substrate 10 (FIG. 1). The powder feeder 40 is used to inject the feedstock powder into the mixing chamber 18 of the nozzle 19. In the present example, nitrogen is used as a carrier fluid to bring the feedstock powder to the nozzle 19.

The water jet unit 32 produces a jet or spray of water travelling at high speed up to 1200 m/s. The waterjet system increases the pressure of water from about 0.5 MPa (tap water) to up to 620 MPa.

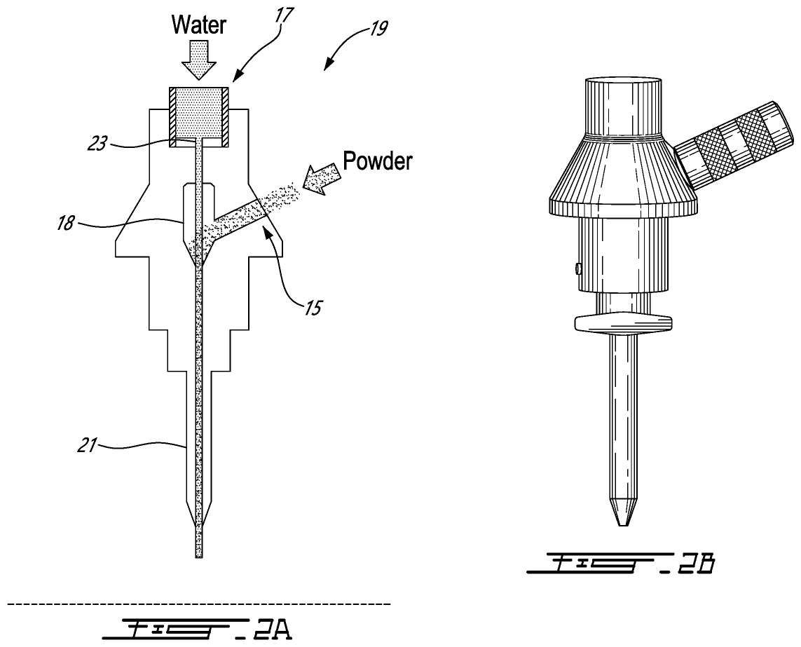

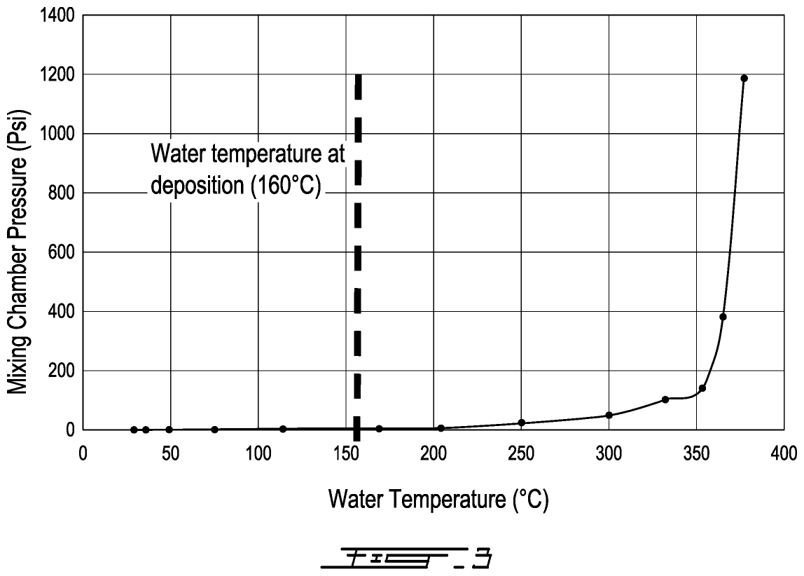

The nozzle 19 is configured for acceleration of the water jet, mixing the water and the feedstock particles, and atomization of the mixture. The nozzle 19 as illustrated for example in FIGS. 2 includes a water inlet, a jewel orifice 23, typically made of extremely hard material such as diamond or tungsten carbide, and converting the high pressure to kinetic energy, a feeding inlet 15, the water and the feedstock particles entering the mixing chamber 18 from separate inlets, the mixing chamber 18, and a focusing tube 21, selected with a selected diameter to length ratio to become more collimated. The kinetic energy transfers from the fast flow of water to the dispersed coating particles in the mixing chamber 18, and, in continue, the mixture of water and powder passes through the focusing tube 21. Finally, the mixture is atomized at the exit of the focusing tube 21, where accelerated particles are sprayed toward the substrate 10. The water droplet at high temperature is evaporated or diverting away from the substrate after the impact.

In experiments, the water, typically at ambient temperature. i.e. about 20° C., is pressurized to a pressure in a range between about 150 and about 620 MPa in a high-pressure pump unit 20, then passed through the heating unit 30 to obtain superheated or supercritical water, in a temperature of at least 150° C., for example in a range between about 150° C. and about 450° C., at the outlet of the heating unit 30.

The heating unit 30 is a welding powder source 1000 Ampere at 44 volts (nominal power of 53 KW at 100% of the duty cycle) configured to increase the water temperature up to 400° C. for high-pressure flow. A tubing electrified and powered by a power supply controlled by a programmable logic controller (PLC) for example is used. A voltage in the range between about 10 and about 40 Volts dc and up to about 1000 amperes is applied. The negative pole of the power supply is grounded and is connected to both the water inlet and the water outlet of the heating unit 30 for safety. The electrified portion of the tubing is insulated to minimize heat loss and is insulated to safeguard against electrical shock and skin burns. The thickness of the walls of the tubing is selected to withstand the pressure, and the length and the diameter of the tubing within the heating unit 30 are selected to optimize the heat transfer to the water by optimizing the residence time of the water in the heated length of tubing depending on the velocity of the water, and by optimizing the heat transfer through the walls of the heated length of tubing. The length of the tubing for heating the water is selected to maximize the contact of the water with the heated length of tubing while using the maximum available energy: if the heating length is too short, the maximum ampere is reached before the maximum voltage is reached, yielding less effective power. For following experiments with a 0.25″ diameter, 0.083″ thick 316 stainless steel tubing, a length of approximately 157″ was selected for the length of the water line between the two poles +/− in the of the heating unit 30 to control the impedance and create a short circuit, for a total heating length of 2×157″ or 314″.

To control the mechanical resistance of the pipes and fittings to plastic deformation at high temperature and high pressure, the tubing temperature is controlled using thermocouples and a controller, to prevent tubing overheating and failure. In the case of a maximum allowable tubing temperature in the system of about 420° C. for example, the water temperature is monitored and controlled for the generation of the superheated or supercritical water.

The water pressure is maintained at about 480 MPa to control the momentum of the particles to accelerate the particles and the water temperature is controlled in the heating unit 30, so as to control the interference of water droplets with the coating upon deposition on the substrate 10 in a spraying cabinet 11 as will be discussed herein below.

The pressure of the powder feeder 40 is controlled in the range between about 0 and about 14 MPa, using pressure gauge 41 in FIG. 1B for example, and maintained higher than the pressure in the mixing chamber 18 which is in the range between about 0 and about 12.5 MPa. The powder may be heated, using a heating coil 24 as illustrated in FIG. 1A for example, using a thermocouple 43 for example, before injection in the mixing chamber 18 of the nozzle 19. A gas such as nitrogen, or air or argon, or a liquid such as water, CO₂ and fluorocarbon for example, may be used as the carrier fluid for injection of the solid particles into the mixing chamber 18.

As illustrated in FIG. 1B, the superheated or supercritical water and the solid powder are injected into the spraying cabinet 11 using the nozzle 19 shown in FIGS. 2 for example. The high pressure superheated or supercritical liquid is fed into the mixing chamber 18 through the jewel orifice 23 of a diameter in a range between 0.1 and 0.4 mm (see FIG. 2A), thereby increasing the fluid velocity. In the mixing chamber 18 of the nozzle 19, the particles are first accelerated by the high velocity liquid jet and then, as the fluid pressure decreases towards atmospheric pressure and the superheated liquid or supercritical fluid expends to gas, mostly by a high velocity gas jet.

The mixture is then projected out through the focusing tube 21 of the nozzle 19. The supercritical or superheated fluid accelerates the particles to velocities above the critical velocity required to adhere particles to the substrate 10, and flashes to gas, so that it does not interference with bonding, manufacturing and coating/component building up upon deposition of the particles on the substrate 10.

The substrate 10 may be heated, selectively in parts of the surface of the substrate 10 most impacted by the particles for example, using a laser for example; the substrate 10 may also be heated so that the substrate 10 remains free of water, using a commercial heater. The temperature is controlled and limited to avoid decomposition of the fluid in case a heat sensitive fluid, such as fluoroketone for example, is selected to spray the particles.

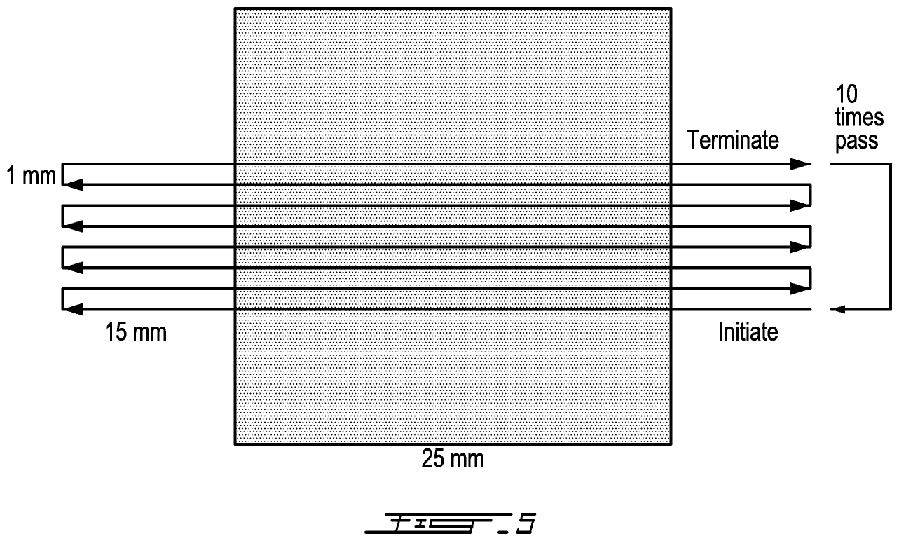

The deposition may be formed on the substrate 10 line by line (see FIG. 5); the substrate 10 may be moved under the spray (see FIG. 4).

The pressure in the system can reach up 620 MPa and the temperature can reach up to 400° C., the maximum operating temperature decreasing with pressure due to the mechanical strength reduction of the metallic components with temperature.

Using supercritical liquid or superheated fluid results in a decrease of the number density of droplets or the number of droplets near the substrate 10, as the amount of water vapor increases, while the particle velocity is still high enough, thereby reducing water-coating deposition interaction. The fluid density is at least 250 kg/m³, which allows accelerating particles of sizes in the range between about 10 and about 300 microns, for example between about 50 and about 150 microns, to a velocity and close to the velocity of the propellant fluid.

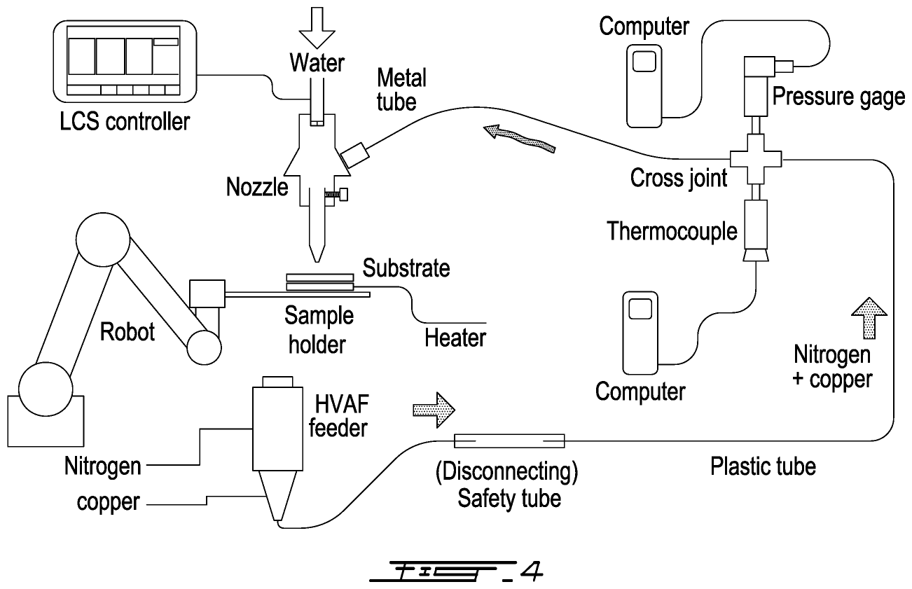

In the above-described method and system, the acceleration of the particles by the water and the elimination of the water by evaporation are controlled, by pressurizing the water in the high-pressure pump unit 20 and then increasing the temperature of the water under the high pressure, to enhance the evaporation of the water at the exit of the nozzle 19. The flow at high speed drags the particles and accelerates them toward the exit of the nozzle 19. Moreover, the high-pressure water is turned into a high-velocity flow at the jewel orifice 23 of the nozzle 19. The water injection parameters, including the range of working pressure and temperature of the water, the geometry of nozzle components such as the size of the orifice, contraction ratio (g), diameter, and length of the focusing tube, the materials and spraying parameters including the flow rate of the carrier fluid, the powder feed rate, the spraying distance, and the substrate temperature are selected and controlled. The temperature and the pressure of the water in the mixing chamber are controlled to control the quality of atomization and optimized pressure for injecting the powder by the feeding system; the mixing chamber pressure and the water temperature are selected so that the water has high internal energy for a target evaporation and the water pressure in the mixing chamber is controllable (see FIG. 3); the pressure in the powder feeder is selected so as to inject the powder into the mixing chamber and prevent the backflow of vapor from the nozzle to the feeder at the working temperature. The nozzle is selectively configured in relation to the pressure variation in terms of the water temperature, by selecting the orifice diameter, the focusing tube diameter, and length at the target working conditions. The water pressure and temperature on deposition may be selected and controlled to achieve efficient acceleration of the particles for deposition and bonding of the particles on the substrate into a uniform deposition over the surface of the substrate. The cohesion of the deposition may also be controlled by controlling the relative velocity between the substrate and the nozzle and the spraying distance or the spraying angle. As people in the art is now in a situation to appreciate, the present disclosure provides windows of deposition for an optimized deposition in a combination of water pressure and temperature.

For example, the Table below provides combinations of parameters in experiments according to an embodiment of the present disclosure:

| Parameter | Unit | | |
|---|---|---|---|
| Propellant material | | Water | Water |
| Propellant pressure | MPa | 310 | 483 |
| Propellant temperature | ° C. | 150-170 | 170-220 |

| | | |
|---|---|---|
| Particle size | μm | 60-170 |

| | | | |
|---|---|---|---|
| Deposition efficiency | % | 2-3 | 65-80 |
| Thickness of deposition | mm | 0.30 | 0.40-2.00 |
| Velocity ratio | | 1.3 | 1.8 |

The thickness of deposition in the above table is an average value obtained for a limited number of passes and a low mass flow rate of powder for spraying under different conditions. The coating thickness may be increased by increasing the number of passes.

The present cold spray method and system efficiently accelerate particles, including large and dense particles, to high particles velocities using high pressure and high velocity superheated or supercritical fluids, for deposition of dense coatings. The density of defects in the coatings produced with large particles is decreased as part of the defects form at the interface between the deposited particles.

The system and method described herein above may be applied for depositing high performance coatings, manufacturing 3D components and repairing damaged components, while minimizing material waste and reducing overall costs.

There is thus provided a method and a system for depositing solid partides on substrates, using high-pressure supercritical or superheated fluids as carrier materials, for cost effective and efficient deposition of dense coatings and additively manufactured parts in a range of materials that can deform or fracture upon impact as in cold gas dynamic spray.

In experiments, the spray distance was 4 cm for an optimum particle size of about 120 microns. The method may comprise controlling a surface condition of the substrate prior to deposition, by preparing a surface of the substrate, by polishing or roughening a surface. Polished substrate surfaces and roughened substrate surfaces were used. Deposition on polished substrate surfaces, as opposed to roughened substrate surfaces, may result in increased adhesion and deposition efficiency.

A safe, inexpensive, and simple fluid such as water, as described in the present disclosure for example, may be used as the working fluid. Other supercritical fluids such as CO₂, nitrogen, fluorocarbon, for example can be used.

As people in the art would now be in a position to appreciate, the present method and system, accelerate particles using a liquid propellant, overcome a number of drawbacks encountered when using gaseous propellant, such as for instance gas consumption and cost, as well as limitations in terms of the maximum particle size that can be efficiently accelerated. Leveraging the high density of the liquid propellant, the method and the system efficiently accelerate particles of a range of sizes, up to the hundred-micron range. Acceleration of both coarse and fine particles over an extended range of feedstock particles size is achieved at significant cost savings, depending on the nature of the fluid, such as water, for example. Spraying of water may also be used to prepare the substrate before spraying the particles. Surface preparation of substrates before cold spray may be performed using one of forced pulsed waterjet (FPWJ), abrasive blasting, laser preparation (ablation/heating), and chemical cleaning. Then, a liquid spraying system may be used for the surface preparation right before deposition by adjusting the pressure and the temperature of the water jet. The water spray may also serve for post-processing of cold spray such as shot peening, heat treatment, material removal, and machining of the deposition.

The scope of the claims should not be limited by the embodiments set forth in the examples but should be given the broadest interpretation consistent with the description as a whole.

1. A system for cold spray deposition of a solid material on
a substrate, comprising:
a fluid jet unit;
a heating unit;
a nozzle, and
a powder feeder;
wherein the fluid jet unit outputs a fluid of a speed up to 1200 m/s and a pressure in a range between 150 and 620 MPa to the heating unit, the heating unit controls a temperature of the fluid to output one of: a superheated and a supercritical fluid; the powder feeder injects feedstock powder particles into a mixing chamber of the nozzle, the feedstock powder particles being accelerated to a speed above a critical velocity of the feedstock powder particles by the fluid within the nozzle, the nozzle being configured for acceleration of the fluid, mixing the fluid and the feedstock powder particles, and projecting the mixture onto the substrate.

2. The system of claim 1, wherein the nozzle comprises a fluid inlet with a jewel orifice leading to the mixing chamber, a powder feedstock particles feeding inlet, the fluid and the powder feedstock particles entering the mixing chamber from respective inlets, and a focusing tube projecting the mixture out of the nozzle onto the substrate.

3. (canceled)

4. The system of claim 1, wherein the powder feeder uses a carrier fluid to inject the feedstock powder particles into the mixing chamber, the carrier fluid being one of: nitrogen, air, argon, water, CO₂ and fluorocarbon.

5. The system of claim 1, wherein the heating unit outputs a fluid at a temperature of at least 150° C.

6. The system of claim 1, wherein the heating unit outputs a fluid at a temperature in a range between 150° C. and 450° C.

7. (canceled)

8. The system of claim 1, wherein a pressure of the powder feeder is controlled to be higher than a pressure in the mixing chamber, the pressure in the mixing chamber being in a range between 0 and 12.5 MPa.

9. (canceled)

10. The system of claim 1, wherein the fluid is one of: water, CO₂, nitrogen, and fluorocarbons.

11. A method for cold spray deposition of a solid material on a substrate, by accelerating solid particles using a one of a superheated or supercritical fluid, the method comprising:
generating a fluid of a speed up to 1200 m/s and a pressure in a range between 150 and 620 MPa;
controlling a temperature of the fluid to yield one of: a superheated and a supercritical fluid;
injecting feedstock powder particles and the fluid into a mixing chamber of a nozzle, the feedstock powder particles being accelerated to a speed above a critical velocity of the feedstock powder particles by the fluid within the nozzle, the nozzle being configured for acceleration of the fluid, mixing the fluid and the feedstock powder particles; and
projecting the mixture onto the substrate.

12. The method of claim 11, wherein the nozzle comprises a fluid inlet with a jewel orifice leading to the mixing chamber, a powder feedstock particles feeding inlet, the fluid and the powder feedstock particles being injected into the mixing chamber from respective inlets, and a focusing tube the mixture being projected out of the nozzle onto the substrate.

13. (canceled)

14. The method of claim 11, wherein the powder feeder uses a carrier fluid to inject the feedstock powder particles into the mixing chamber, the carrier fluid being one of: nitrogen, air, argon, water, CO₂ and fluorocarbon.

15. The method of claim 11, wherein said controlling the temperature of the fluid to yield one of: a superheated and a supercritical fluid comprises controlling the temperature of the fluid to at least 150° C.

16. The method of claim 11, wherein said controlling the temperature of the fluid to yield one of: a superheated and a supercritical fluid comprises controlling the temperature of the fluid in a range between 150° C. and 450° C.

17. (canceled)

18. The method of claim 11, comprising controlling a pressure of the feedstock powder particles for injection into the mixing chamber of the nozzle to be higher than a pressure in the mixing chamber, the pressure in the mixing chamber being in a range between 0 and 12.5 MPa.

19. (canceled)

20. The method of claim 11, wherein the fluid is one of: water, CO₂, nitrogen, and fluorocarbons.

21. The method of claim 11, further comprising selecting a distance between an exit of the nozzle and the substrate in a range between 2 and 20 cm.

22. The method of claim 11, further comprising selecting a distance between an exit of the nozzle and the substrate in a range of 3 to 5 cm.

23. The method of claim 11, wherein a particle size of the feedstock powder particles 10 to 300 microns.

24. The method of claim 11, wherein a particle size of the feedstock powder particles 50 to 150 microns.

25. The method of claim 11, comprising preparing a surface of the substrate.

26. The method of claim 11, comprising one of: polishing and roughening a surface of the substrate prior to deposition.
